(19) United States
(12) Patent Application Publication
(10) Pub. No.: US 2014/0019723 A1
(43) Pub. Date: Jan. 16, 2014

(54) BINARY TRANSLATION IN ASYMMETRIC MULTIPROCESSOR SYSTEM

(71) Applicants: Koichi Yamada, Los Gatos, CA (US); Ronny Ronen, Haifa (IL); Wei Li, Palo Alto, CA (US); Boris Ginzburg, Haifa (IL); Gadi Haber, Nesher (IL); Konstantin Levit-Gurevich, Kiryat-Bialik (IL); Esfir Natanzon, Haifa (IL); Alon Naveh, Ramat Hasharon (IL); Eliezer Weissmann, Haifa (IL); Michael Mishaeli, Zichron Yaakov (IL)

(72) Inventors: Koichi Yamada, Los Gatos, CA (US); Ronny Ronen, Haifa (IL); Wei Li, Palo Alto, CA (US); Boris Ginzburg, Haifa (IL); Gadi Haber, Nesher (IL); Konstantin Levit-Gurevich, Kiryat-Bialik (IL); Esfir Natanzon, Haifa (IL); Alon Naveh, Ramat Hasharon (IL); Eliezer Weissmann, Haifa (IL); Michael Mishaeli, Zichron Yaakov (IL)

(21) Appl. No.: 13/993,042

(22) PCT Filed: Dec. 28, 2011
(86) PCT No.: PCT/US11/67654

§ 371 Date: Jun. 10, 2013

(51) Int. Cl. G06F 9/30

(52) U.S. Cl. CPC G06F 9/30145
USPC 712/208

(57) ABSTRACT

An asymmetric multiprocessor system (ASMP) may comprise computational cores implementing different instruction set architectures and having different power requirements. Program code for execution on the ASMP is analyzed and a determination is made as to whether to allow the program code, or a code segment thereof to execute on a first core natively or to use binary translation on the code and execute the translated code on a second core which consumes less power than the first core during execution.

### TECHNICAL FIELD

The invention described herein relates to the field of microprocessor architecture. More particularly, the invention relates to binary translation in asymmetric multiprocessor systems.

### BACKGROUND

An asymmetric multiprocessor system (ASMP) combines computational cores of different capabilities or specifications. For example, a first “big” core may contain a different arrangement of logic elements than a second “small” core. Threads executing program code on the ASMP would benefit from operating-system transparent core migration of program code between the different cores.

### BRIEF DESCRIPTION OF THE DRAWINGS

The detailed description is set forth with reference to the accompanying figures. In the figures, the left-most digit(s) of a reference number identifies the figure in which the reference number first appears. The use of the same reference numbers in different figures indicates similar or identical items or features.

FIG. 1 illustrates a portion of an architecture of an asymmetric multiprocessor system (ASMP) providing for binary translation of program code.

FIG. 2 illustrates a thread and code segments thereof having instructions which are native to different processing cores in the ASMP having different instruction set architectures.

FIG. 3 is an illustrative process of selecting when to migrate or translate code segments for execution on the processors in the ASMP.

FIG. 4 is another illustrative process of selecting when to migrate or translate code segments for execution on the cores in the ASMP.

FIG. 5 is yet another illustrative process of selecting when to migrate or translate code segments for execution on the cores in the ASMP.

FIG. 6 is an illustrative process of mitigating back migration.

FIG. 7 is an illustrative process of mitigating back migration by preventing migration until a pre-determined cycle execution counter threshold is reached.

FIG. 8 is another illustrative process of mitigating back migration by preventing migration until a pre-determined cycle execution counter threshold is reached.

FIG. 9 is an illustrative process of migrating based at least in part on use of a binary analyzer.

FIG. 10 is a block diagram of an illustrative system to perform migration of program code between asymmetric cores.

FIG. 11 is a block diagram of a processor according to one embodiment.

FIG. 12 is a schematic diagram of an illustrative asymmetric multi-core processing unit that uses an interconnect arranged as a ring structure.

FIG. 13 is a schematic diagram of an illustrative asymmetric multi-core processing unit that uses an interconnect arranged as a mesh.

FIG. 14 is a schematic diagram of an illustrative asymmetric multi-core processing unit that uses an interconnect arranged in a peer-to-peer configuration.

### DETAILED DESCRIPTION

Architecture

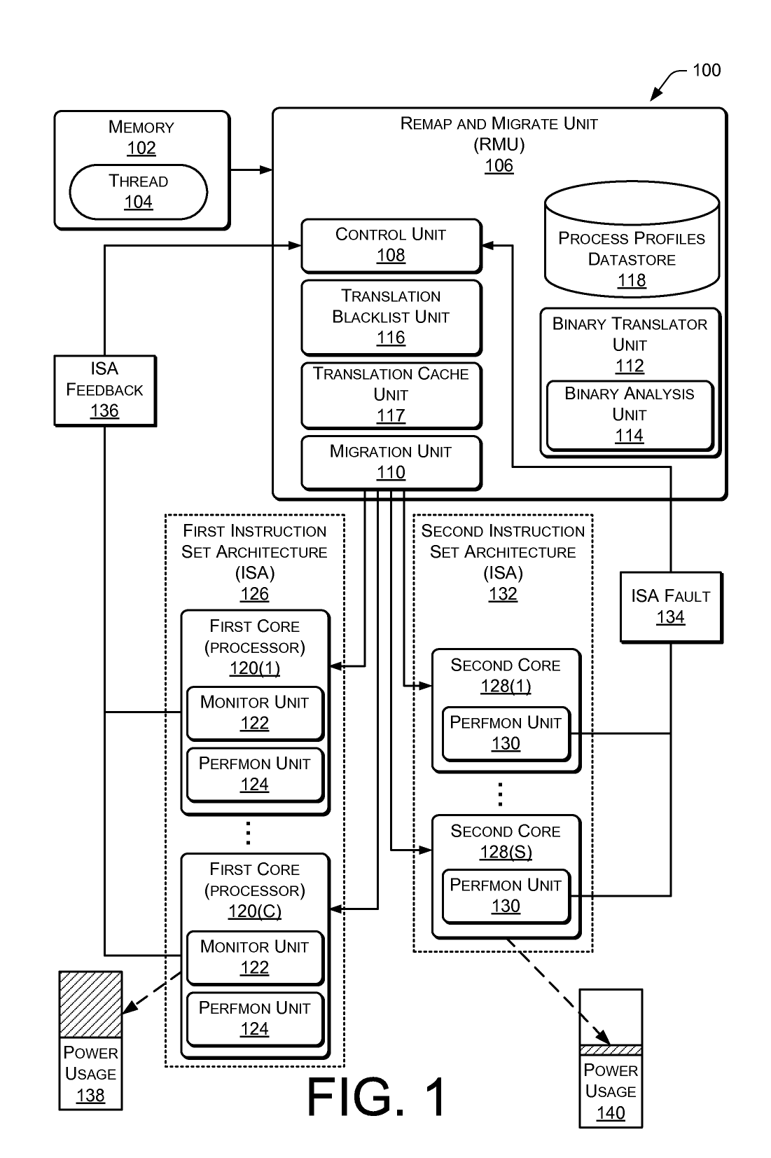

FIG. 1 illustrates a portion of an architecture 100 of an asymmetric multiprocessor system (ASMP). As described herein, this architecture provides for binary translation of program code and the migration of program code between cores using a remap and migrate unit (RMU) with a binary translator unit and a binary analysis unit.

A memory 102 comprises computer-readable storage media (“CRSM”) and may be any available physical media accessible by a processing core or other device to implement the instructions stored thereon or store data within. The memory 102 may comprise a plurality of logic elements having electrical components including transistors, capacitors, resistors, inductors, memristors, and so forth. The memory 102 may include, but is not limited to, random access memory (“RAM”), read-only memory (“ROM”), electrically erasable programmable read-only memory (“EEPROM”), flash memory, magnetic storage devices, and so forth.

Within the memory 102 may be stored an operating system (not shown). The operating system is configured to manage hardware and services within the architecture 100 for the benefit of the operating system (“OS”) and one or more applications. During execution of the OS and/or one or more applications, one or more threads 104 are generated for execution by a core or other processor. Each thread 104 comprises program code 106.

A remap and migrate unit (RMU) 106 comprises logic, circuitry, internal program code, or a combination thereof which receives the thread 104 and migrates, translates, or both the program code therein for execution across an asymmetric plurality of cores for execution. The asymmetry of the architecture results from two or more cores having different instruction set architectures, different logical elements, different physical construction, and so forth.

The RMU 106 comprises a control unit 108, migration unit 110, binary translator unit 112, binary analysis unit 114, translation blacklist unit 116, a translation cache unit 117, and a process profiles datastore 118.

Coupled to the remap and migrate unit 106 are one or more first cores (or processors) 120(1), 120(2), . . . , 120(C). These cores may comprise one or more monitor units 122, performance monitoring, one or more “perfmon” units 124, and so forth. The monitor unit 122 is configured to monitor instruction set architecture usage, performance, and so forth. The perfmon 124 is configured to monitor functions of the core such as execution cycles, power state, and so forth. These first cores 120 implement a first instruction set architecture (ISA) 126.

Also coupled to the remap and migrate unit 106 are one or more second cores 128(1), 128(2), . . . , 128(S). The second cores 128 may also incorporate one or more perfmon units 130. These second cores 128 implement a second ISA 132. In some implementations the quantity of the first cores 120 and the second cores 128 may be asymmetrical. For example, there may be a single first core 120(1) and three second cores 128(1), 128(2), and 128(3). While two instruction set architectures are depicted, it is understood that more ISAs may be present in the architecture 100. The ISAs in the ASMP architecture 100 may differ from one another, but one ISA may be a subset of another. For example, the second ISA 132 may be a subset of the first ISA 126.

In some implementations the first cores 120 and the second cores 128 may be coupled to one another using a bus. The first cores 120 and the second cores 128 may be configured to share cache memory or other logic. As used herein, cores include, but are not limited to, central processing units (CPUs), graphics processing units (GPUs), floating point units (FPUs) and so forth.

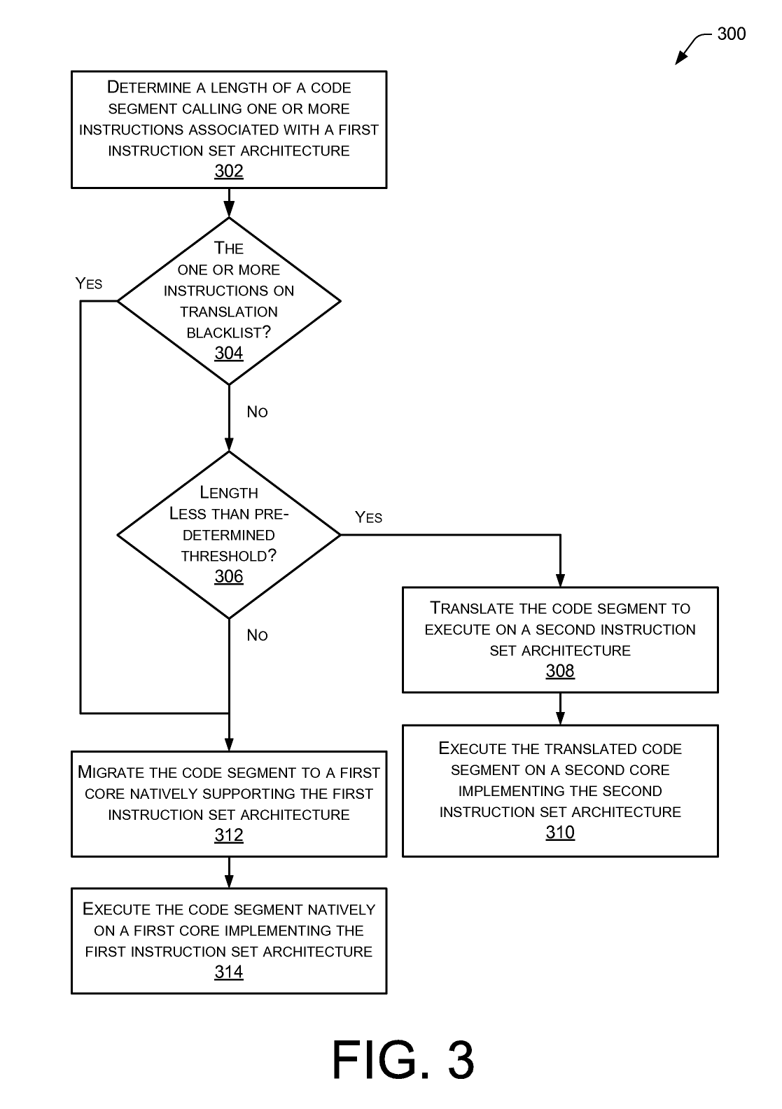

The control unit 108 comprises logic to determine when to migrate, translate, or both, as described below in more detail with regards to FIGS. 3-9. The migration unit 110 manages migration of the thread 104 between cores 120 and 128.

The binary translator unit 112 contains logic to translate instructions in the thread 104 from one instruction set architecture to another instruction set architecture. For example, the binary translator unit 112 may translate instructions which are native to the first ISA 126 of the first core 120 to the second ISA 132 such that the translated instructions are executable on the second core 128. Such translation allows for the second core 128 to execute program code in the thread 104 which would otherwise generate a fault, due to the instruction not being supported by the second ISA 132.

The binary analysis unit 114 is configured to provide binary analysis of the thread 104. This binary analysis 104 may include identifying particular instructions, determining on what ISA the instructions are native, and so forth. This determination may be used to select which of the cores to execute the thread 104 or portions thereof upon. In some implementations, the binary analysis unit 114 may be configured to insert instructions such as control micro-operations into the program code of the thread 104.

A translation blacklist unit 116 maintains a set of instructions which are blacklisted from translation. For example, in some implementations a particular instruction may be unacceptably time intensive to generate a binary translated, and thus be precluded from translation. In another example, a particular instruction may be more frequently executed and thus be more effectively executed on the core for which the instruction is native, and be precluded from translation for execution on another core. In some implementations a whitelist indicating instructions which are to be translated may be used instead of or in addition to the blacklist.

The translation cache unit 117 within RMU 106 provides storage for translated program code. An address lookup mechanisms may be provided which allows previously translated program code to be stored and recalled for execution. This improves performance by avoiding retranslation of the original program code.

As shown here, the remap and migrate unit 106 may comprise memory to store process profiles, forming a process profiles datastore 118. The process profiles datastore 118 contains data about the threads 104 and their execution.

The control unit 108 of the remap and migrate unit 106 may receive ISA faults 134 from the second cores 128. For example, when the thread 104 contains an instruction which is non-native to the second ISA 132 as implemented by the second core 128, the ISA fault 134 provides notice to the remap and migrate unit 106 of this failure. The remap and migrate unit 106 may also receive ISA feedback 136 from the cores, such as the first cores 120. The ISA feedback 136 may comprise data about the types of instructions used during execution, processor status, and so forth. The remap and migrate unit 106 may use the ISA fault 134 and the ISA feedback 136 at least in part to modify migration and translation of the program code 106 across the cores.

The first cores 120 and the second cores 128 may use differing amounts of power during execution of the program code. For example, the first cores 120 may individually consume a first maximum power during normal operation at a maximum frequency and voltage within design specifications for these cores. The first cores 120 may be configured to enter various lower power states including low power or standby states during which the first cores 120 consume a first minimum power, such as zero when off. In contrast, the second cores 128 may individually consume a second maximum power during normal operation at a maximum frequency and voltage within design specification for these cores. The second maximum power may be less than the first maximum power. This may occur for many reasons, including the second cores 128 having fewer logic elements than the first cores 120, different semiconductor construction, and so forth. As shown here, a graph depicts maximum power usage 138 of the first core 120 compared to maximum power usage 140 of the second core 128. The power usage 138 is greater than the power usage 140.

The remap and migration unit 106 may use the ISA feedback 136, the ISA faults 134, results from the binary analysis unit 114, and so forth to determine when and how to migrate the thread 104 between the first cores 120 and the second cores 128 or translate at least a portion of the program code of the thread 104 to reduce power consumption, increase overall utilization of compute resources, provide for native execution of instructions, and so forth. In one implementation to minimize power consumption, the thread 104 may be translated and executed on the second core 128 having lower power usage 140. As a result, the first core 120, which consumes more electrical power remains in a low power or off mode.

The remap and migration unit 106 may also determine translation and migration of program code by looking at change in a “P-state.” The P-state of a core indicates an operational level of performance, such as may be defined by a particular combination of frequency and operating voltage of the core. For example, a high P-state may involve the core executing at its maximum design frequency and voltage. When an operating system changes the P-state and indicates a transition to the low power and performance state, the remap and migration unit 106 may initiate migration from the first core 120 to the second core 128 to minimize the power consumption.

In some implementations, such as in systems-on-a-chip, several of the elements described in FIG. 1 may be disposed on a single die. For example, the first cores 120, the second cores 128, the memory 102, the RMU 106, and so forth may be disposed on the same die.

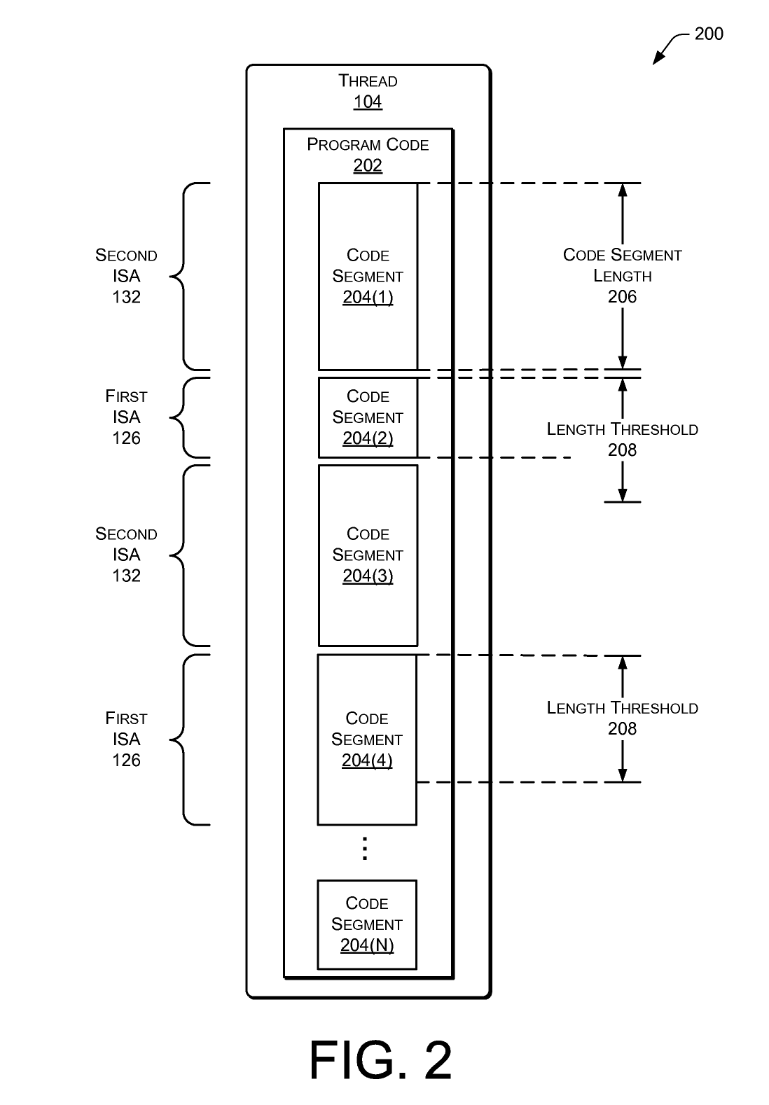

FIG. 2 illustrates a thread and code segments thereof which are native to different processors in the ASMP having different instruction set architectures. The thread 104 is depicted comprising program code 202. This program code 202 may further be divided into code segments 204(1), 204(2), . . . , 204(N). The code segments 204 contain instructions for execution on a core. The program code 202 may be distributed into the code segments 204 based upon functions called, instruction set used, instruction complexity, length, and so forth.

Shown here are a sequence of code segments 204(1), 204(2), . . . , 204(N) of varying length. Indicated in this illustration are the instruction set architectures for which instructions in the code segments 204 are native. Native instructions are those which may be executed by the core without binary translation. Here, at least code segments 204(1) and 204(3) are native for the second ISA 132 while the code segments 204(2) and 204(4) are native to the first ISA 126.

The code segments 204 may be of varying code segment length 206. In some implementations, the code segments 204 may be considered basic blocks. As such, they have a single entry point and a single exit point, and may contain a loop. The length may be determined by the binary analysis unit 114 or other logic. The length may be given in data size of the instructions, count of instructions, and so forth. Where the code segments 204 comprise loops, control flow may be taken into account such that the actual length of the program code 202 during execution is considered. For example, a code segment 204 having a length of one which contains a loop of ten iterations may be considered during execution to have a code segment length 206 of ten.

The code segment length 206 may be used to determine whether the code segment 204 is to be translated or migrated. The code segment length 206 may be compared to a pre-determined code segment length threshold 208. Where the code segment length 206 is less than the threshold 208, translation may occur. Where larger, migration may be used, although in some implementations translation may occur concurrently.

For this illustration, consider that the second ISA 132 is a subset of the first ISA 126. That is, the first ISA 126 is able to execute a majority or totality of the instructions present in the second ISA 132. To minimize power consumption, the RMU 106 may attempt to maximize execution on the second core 128 which utilizes less power 140 than the first core 120. Without binary translation, instructions may generate faults on the second core 128, which would call migration of the thread 104 to the first core 120 for execution. For code segments such as 204(2) which are below the length threshold 208, binary translation may provide acceptable net power savings, acceptable execution times, and so forth. However, for code segments such as 204(4) which exceed the length threshold 208, binary translation may result in increased power consumption, reduced execution times, and so forth. The length threshold 208 may be statically configured or dynamically adjusted.

In addition to the code segment length 206, in some implementations a density of the ISA usage in the code segment 204 which is specific to a particular core may be considered. Consider when the code segment 204(2) is considered native to the first ISA 126 but comprises a mixture of instructions in common between the first ISA 126 and the second ISA 132. When the density of the ISA native to the ISA 126 is below a pre-determined limit, the length threshold 208 may be increased. Thus, the density of instructions for a particular ISA may be used to vary the length threshold 208.

Illustrative Processes

The processes described in this disclosure may be implemented by the devices described herein, or by other devices. These processes are illustrated as a collection of blocks in a logical flow graph. Some of the blocks represent operations that can be implemented in hardware, software, or a combination thereof. In the context of software, the blocks represent computer-executable instructions stored on one or more computer-readable storage media that, when executed by one or more processors, perform the recited operations. Generally, computer-executable instructions include routines, programs, objects, components, data structures, and the like that perform particular functions or implement particular abstract data types. In the context of hardware, the blocks represent arrangements of circuitry configured to provide the recited operations. The order in which the operations are described is not intended to be construed as a limitation, and any number of the described blocks can be combined in any order or in parallel to implement the processes.

FIG. 3 is an illustrative process 300 of selecting when to migrate or translate code segments for execution on the processors in the ASMP. As described above, the RMU 106 comprises logic to determine when to migrate, translate, or both by implementing the following process. As shown here, at 302, the length 206 of the code segment 204 which calls one or more instructions associated with the first ISA 126 is determined. For example, the binary analysis unit 114 may determine the length 206.

At 304, when the one or more instructions are not on a translation blacklist in the translation blacklist unit 116, the process proceeds 306. At 306, when the code segment length 206 is less than the pre-determined length threshold 208, the process proceeds to 308. At 308, the code segment 204 is translated by the binary translator unit 112 to execute on the second ISA 132. At 310, the translated code segment is executed on the second core 128 implementing the second ISA 132.

Returning to 304, when the one or more instructions are on the translation blacklist, the process proceeds to 312. At 312, the code segment 204 is migrated to the first core 120 which natively supports the one or more instructions therein. At 314, the code segment 304 is natively executed on the first core 120.

Returning to 306, when the code segment length 206 is not less than the pre-determined length threshold 208, the process proceeds to 312 to migrate the code segment 204.

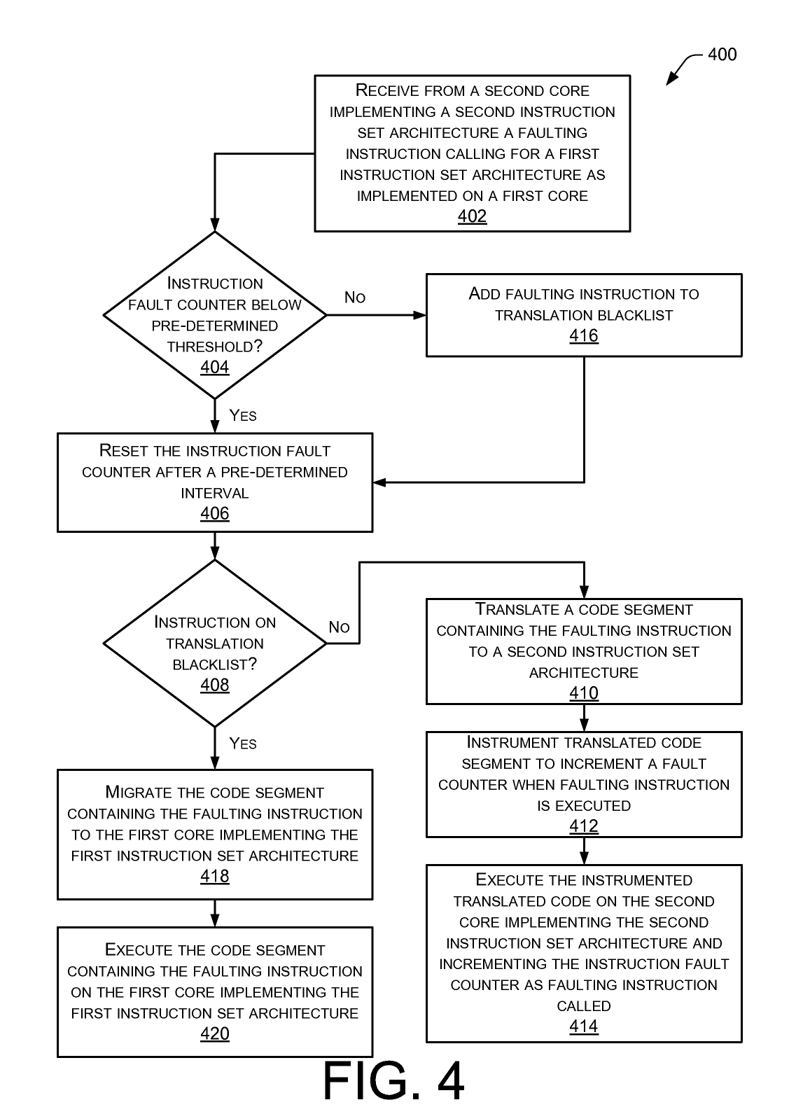

FIG. 4 is another illustrative process 400 of selecting when to migrate or translate code segments 204 for execution on the cores in the ASMP. The RMU 106 comprises logic to determine when to migrate, translate, or both by implementing the following process.

At 402, the RMU 106 receives from the second core 128 a faulting instruction which calls for the first ISA 126 as implemented on the first core 120. Stated another way, the second core 128 has encountered an instruction in the program code 202 of the thread 104 which cannot be natively executed in the second ISA 132 of the second core 128.

At 404, when an instruction fault counter is below a pre-determined threshold the process proceeds to 406 and resets the instruction fault counter after a pre-determined interval. This reset helps avoid problems with “stickiness” in the selection of migration.

At 408, when an instruction is not on the translation blacklist, the process proceeds to 410. At 410, the code segment 204 containing the faulting instruction is translated by the binary translator unit 112 such that the translated program code is executable in the second ISA 132.

At 412, the translated code segment is instrumented to increment a fault counter when the faulting instruction is executed. For example, the binary analysis unit 114 may insert instrumented code into the code segment 204. At 414, the instrumented translated code is executed on the second core 128 which implements the second ISA 132. The instrumented code increments the fault counter as the faulting instruction is called by the second core 128.

In some implementations, after execution of the instrumented translated code at 414, the process may determined when the instruction fault counter is below a pre-determined threshold such as described above with respect to 404. When below the pre-determined threshold the process may reset the instruction fault counter after the pre-determined interval and proceed to 418 as described below to begin migration and execution of the code segment.

Returning to 404, when the instruction fault counter is no longer below the pre-determined threshold, the process proceeds to 416. At 416, the faulting instruction is added to the translation blacklist as maintained by the translation blacklist unit 116. The process may then proceed to 406 as described above.

Returning to 408, when the instruction is on the translation blacklist as maintained by the translation blacklist unit 116, the process proceeds to 418. At 418, the code segment 204 containing the faulting instruction is migrated to the first core 120 implementing the first ISA 126. At 420, the code segment 204 containing the faulting instruction is executed on the first core 120.

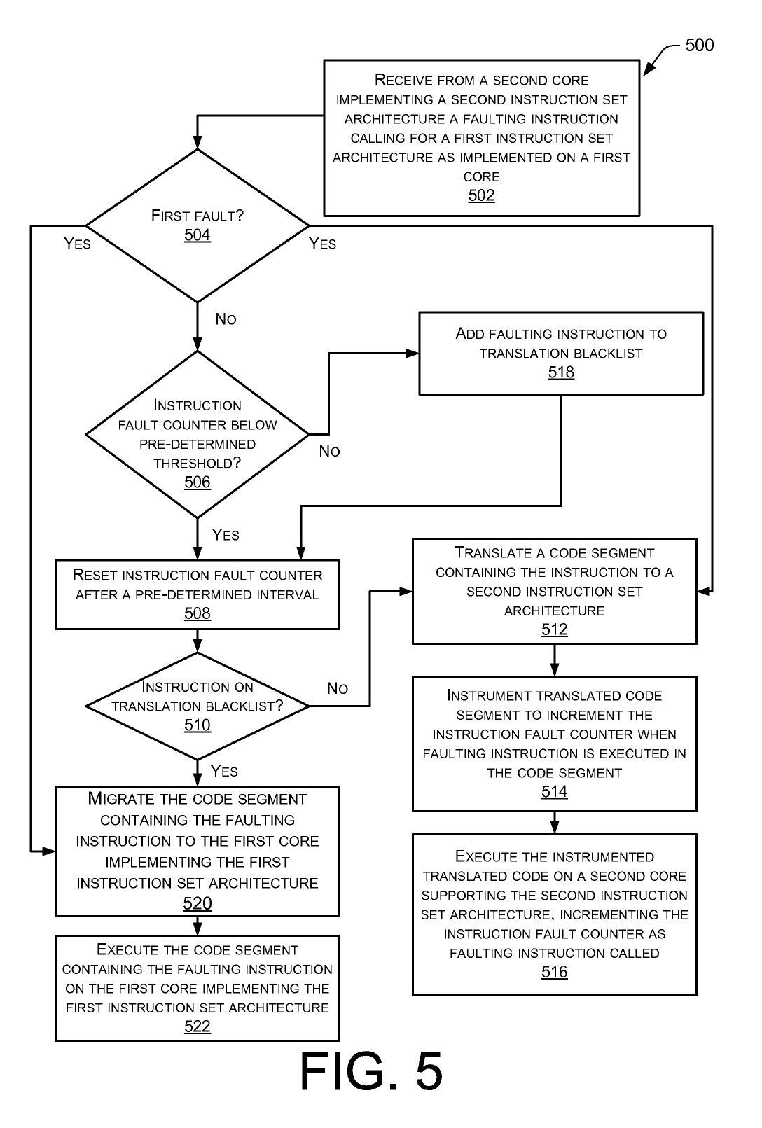

FIG. 5 is another illustrative process 500 of selecting when to migrate or translate code segments for execution on the cores in the ASMP. The RMU 106 may implement the following process.

At 502, the RMU 106 receives from the second core 128 a faulting instruction which calls for the first ISA 126 as implemented on the first core 120. Stated another way, the second core 128 has encountered an instruction in the program code 202 of the thread 104 which cannot be natively executed in the second ISA 132 of the second core 128.

At 504, when this is not a first fault for this instruction, the process proceeds to 506. At 506, when an instruction fault counter is below a pre-determined threshold the process proceeds to 508. At 508, the instruction fault counter is reset after a pre-determined interval.

At 510, when an instruction is not on a translation blacklist, the process proceeds to 512. At 512, the code segment 204 containing the faulting instruction is translated by the binary translator unit 112 such that the translated program code is executable in the second ISA 132.

At 514, the translated code segment is instrumented to increment a fault counter when the faulting instruction is executed. For example, the binary analysis unit 114 may insert instrumented code into the code segment 204. At 516, the instrumented translated code is executed on the second core 128 which implements the second ISA 132. The instrumented code increments the fault counter as the faulting instruction is called by the second core 128.

Returning to 506, when the instruction fault counter is no longer below the pre-determined threshold, the process proceeds to 518. At 518, the faulting instruction is added to the translation blacklist as maintained by the translation blacklist unit 116. The process may then proceed to 508 as described above.

Returning to 510, when the instruction is on the translation blacklist as maintained by the translation blacklist unit 116, the process proceeds to 520. At 520, the code segment 204 containing the faulting instruction is migrated to the first core 120 implementing the first ISA 126. At 522, the code segment 204 containing the faulting instruction is executed on the first core 120.

Returning to 504, when this is a first fault, the process proceeds concurrently to 512 and 520. Thus, the binary translation of the code segment 204 takes place while also migrating the code segment 204 for native execution on the first core 120. When the binary translation is complete, the thread 104 may be migrated back to the second core 128 using the translated code segment. By concurrently performing these operations overall responsiveness remains substantially unaffected by the translation process.

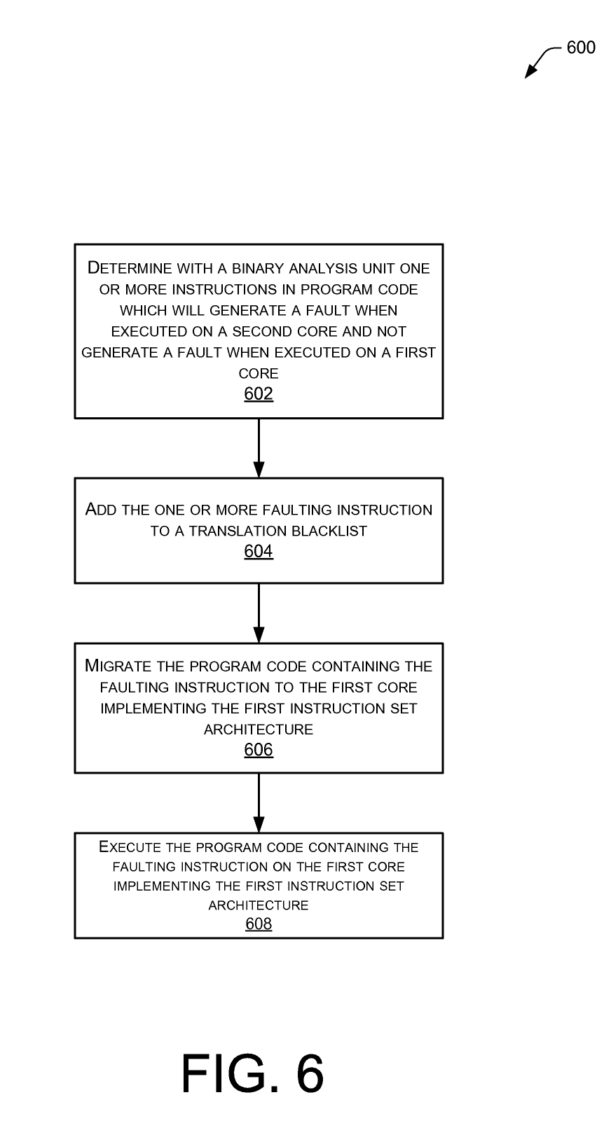

FIG. 6 is an illustrative process 600 of mitigating back migration. Back migration occurs when the thread 104 is migrated to one core than back to the other within a short time. Such back migration introduces undesirable performance impacts. The following processes may be incorporated into the processes described above with regards to FIGS. 3-5. The RMU 106 may implement the following process.

At 602, the binary analysis unit 112 determines one or more instructions in the program code 202 of the thread 104 will generate a fault when executed on the second core 128 and not generate a fault when executed on the first core 120. For example, the one or more instructions may be native to the first ISA 126 and not the second 132.

At 604, one or more of the determined instructions which would generate a fault are added to a translation blacklist. The translation blacklist may be maintained by the translation blacklist unit 116. Instructions present in the translation blacklist are prevented from being migrated from the first core 120 to the second core 128 and thus are not translated. As described above with regards to FIGS. 3 and 4, the translation blacklist may be used to determine when the code segment 204 which is executed on the second core 128 as a translation may be migrated to the first core 120 for native execution. For example, after initial translation and execution on the second core 128, the instruction may be added to the translation blacklist. Following this addition, the code may be migrated from the second core 128 to the first core 120. Changes to the blacklist may be made based in part on a number of faulting instructions and frequency of execution within the code segment 204. The RMU 106 may thus implement a threshold frequency which, when reached, adds the faulting instruction to the blacklist. This threshold frequency may be fixed or dynamically adjustable.

At 606, the program code 202 containing the faulting instruction is migrated to the first core 120 which implements the first ISA 126. At 608, the program code 202 containing the faulting instruction is executed on the first core 120 which implements the first ISA 126. As a result, the program code 202 executes without faulting.

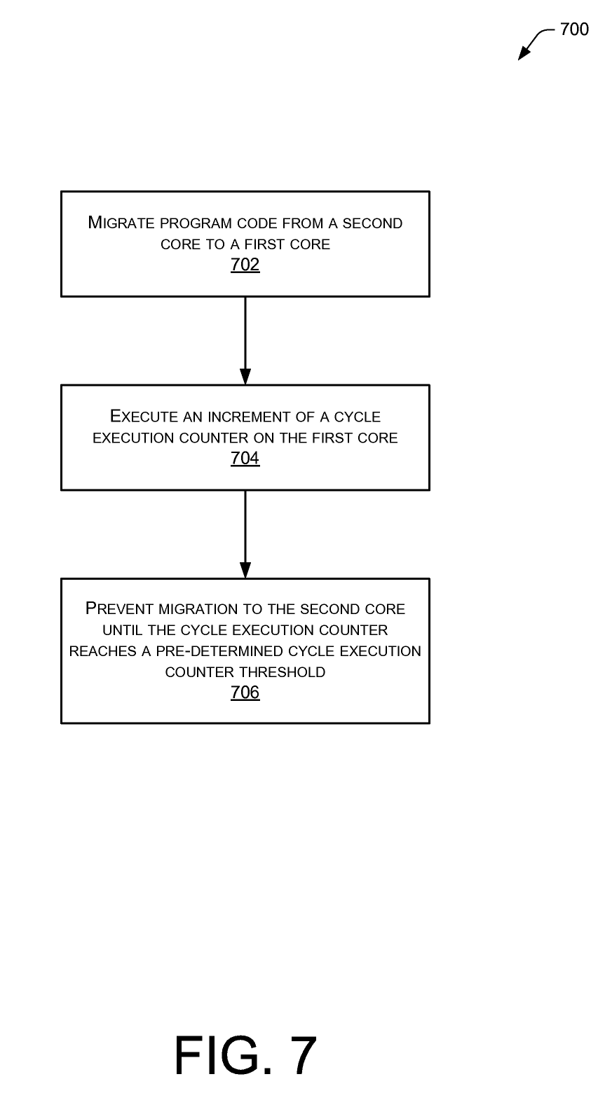

FIG. 7 is an illustrative process 700 of mitigating back migration by preventing migration until a pre-determined cycle execution counter threshold is reached. At 702, the program code 202 of the thread 104 is migrated from the second core 128 to the first core 120. The RMU 106 may implement the following process.

At 704, an increment of a cycle execution counter is executed on the first core 120. In some implementations a delay counter may be used. In another implementation, this counter may be derived from performance monitor data, such as generated by the perfmon unit 124.

At 706, migration to the second core 128 is prevented until the cycle execution counter reaches a pre-determined cycle execution counter threshold. This may override other considerations, such as power reduction. Where the cost of the transition between cores is known, the overhead of transitions-time/overall-time may be reduced. For example, when a transition uses 5,000 cycles and the pre-determined cycle execution threshold is 500,000 cycles before transitions from the first core 120 to the second core 128 overhead is limited to less than about 2%, assuming a transition again immediately after moving to the second core 128.

In some implementations the pre-determined cycle execution counter threshold may be asymmetrical. For example, a threshold for transitions from the first core 120 to the second core 128 may be different than a threshold for transitions from the second core 128 to the first core 120.

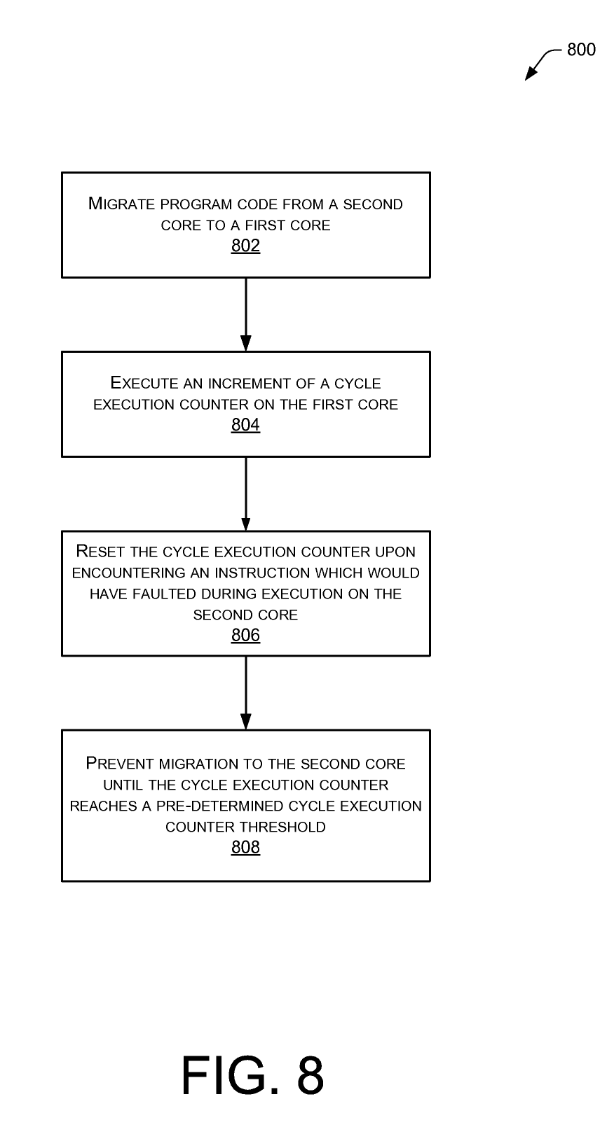

FIG. 8 is another illustrative process 800 of mitigating back migration by preventing migration until a pre-determined cycle execution counter threshold is reached. The RMU 106 may implement the following process.

At 802, the program code 102 of the thread 104 is migrated from the second core 128 to the first core 120. At 804, an increment of a cycle execution counter on the first core 120 is executed. In some implementations this counter may be maintained by the perfmon unit 124.

At 806, the cycle execution counter is reset upon encountering an instruction which would have faulted during execution on the second core 128. At 808, migration to the second core 128 is prevented until the cycle execution counter reaches a pre-determined cycle execution threshold. This process mitigates situations where the thread 104 moves from the first core 120 to the second core 128 and then quickly back to the first core 120. The value of the cycle execution threshold may vary depending upon information about the average or expected transition cost. This information may be derived from the ISA feedback 136 and provided by the monitor unit 122 in some implementations.

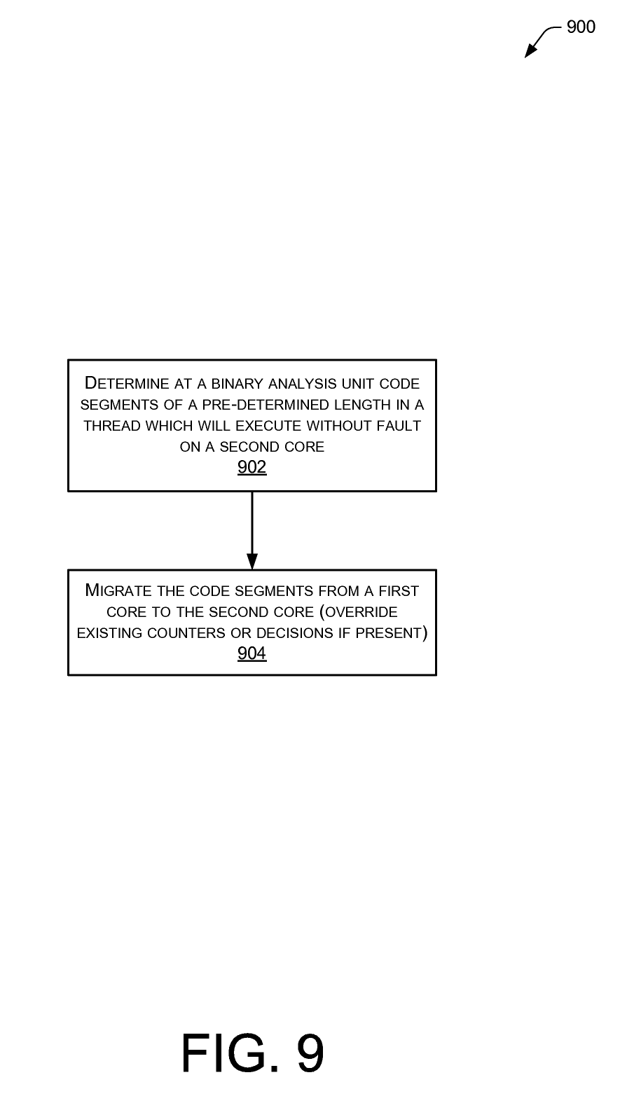

FIG. 9 is an illustrative process 900 of migrating based at least in part on use of a binary analyzer. The RMU 106 may implement the following process. As described above, the binary analysis unit 114 is configured to perform binary analysis on the program code 202 of the thread 104. The binary analysis may include determination of instructions called, instruction set architectures used by those instructions, and so forth.

At 902, the binary analysis unit 114 determines code segments 204 of a pre-determined length in the thread 104 which will execute without fault on the second core 128. This pre-determined length may be static or dynamically set.

At 904, the code segments 204 are migrated from the first core 120 to the second core 128. This migration overrides or occurs regardless of other counters or thresholds. This process improves system performance by analyzing the program code 202 and providing for a proactive migration. Thus, rather than waiting for thresholds to be reached, the migration occurs. For example, the binary analysis unit 114 may determine the code segment 204 has a loop of one million iterations of an instruction which will not fault when executed on the second core 128. Given this, the migration from the first core 120 may override a wait for counters to reach a pre-determined threshold level. Such proactive migration further reduces power consumption by reducing usage of the first core 120.

In some implementations, dynamic counters may be used to override pre-determined migration point. For example, the code segment 204 may have been analyzed to execute without faults but during actual execution actually generates faults when executing on the second core 128. These faults may increment dynamic counters and thus result in migration. The process 900 may be used in conjunction with the other processes described above with regards to FIGS. 3-8.

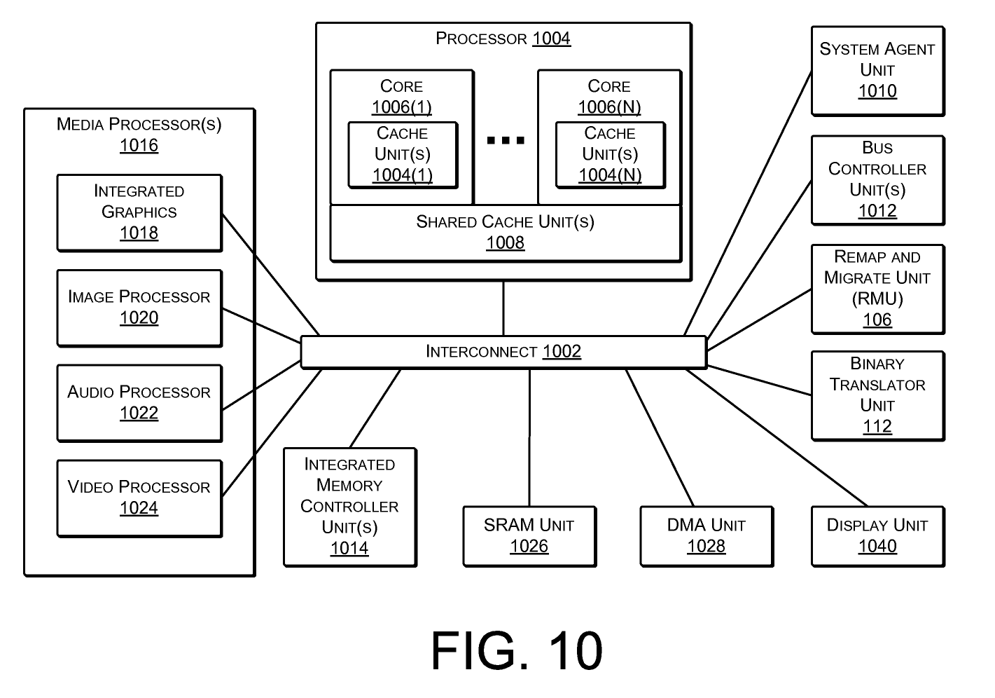

FIG. 10 is a block diagram of an illustrative system 1000 to perform migration of program code between asymmetric cores. This system may be implemented as a system-on-a-chip (SoC). An interconnect unit(s) 1002 is coupled to: one or more processors 1004 which includes a set of one or more cores 1006(1)-(N) and shared cache unit(s) 1008; a system agent unit 1010; a bus controller unit(s) 1012; an integrated memory controller unit(s) 1014; a set or one or more media processors 1016 which may include integrated graphics logic 1018, an image processor 1020 for providing still and/or video camera functionality, an audio processor 1022 for providing hardware audio acceleration, and a video processor 1024 for providing video encode/decode acceleration; an static random access memory (SRAM) unit 1026; a direct memory access (DMA) unit 1028; and a display unit 1040 for coupling to one or more external displays. In one implementation the RMU 106, the binary translator unit 112, or both may couple to the cores 1006 via the interconnect 1002. In another implementation, the RMU 106, the binary analysis unit 112, or both may couple to the cores 1006 via another interconnect between the cores.

The processor(s) 1004 may comprise one or more cores 1006(1), 1006(2), . . . , 1006(N). These cores 1006 may comprise the first cores 120(1)-120(C), the second cores 128(1)-128(S), and so forth. In some implementations, the processors 1004 may comprise a single type of core such as the first core 120, while in other implementations, the processors 1004 may comprise two or more distinct types of cores, such as the first cores 120, the second cores 128, and so forth. Each core may include an instance of logic to perform various tasks for that respective core. The logic may include one or more of dedicated circuits, logic units, microcode, or the like.

The set of shared cache units 1008 may include one or more mid-level caches, such as level 2 (L2), level 3 (L3), level 4 (L4), or other levels of cache, a last level cache (LLC), and/or combinations thereof. The system agent unit 1010 includes those components coordinating and operating cores 1006(1)-(N). The system agent unit 1010 may include for example a power control unit (PCU) and a display unit. The PCU may be or include logic and components needed for regulating the power state of the cores 1006(1)-(N) and the integrated graphics logic 1018. The display unit is for driving one or more externally connected displays.

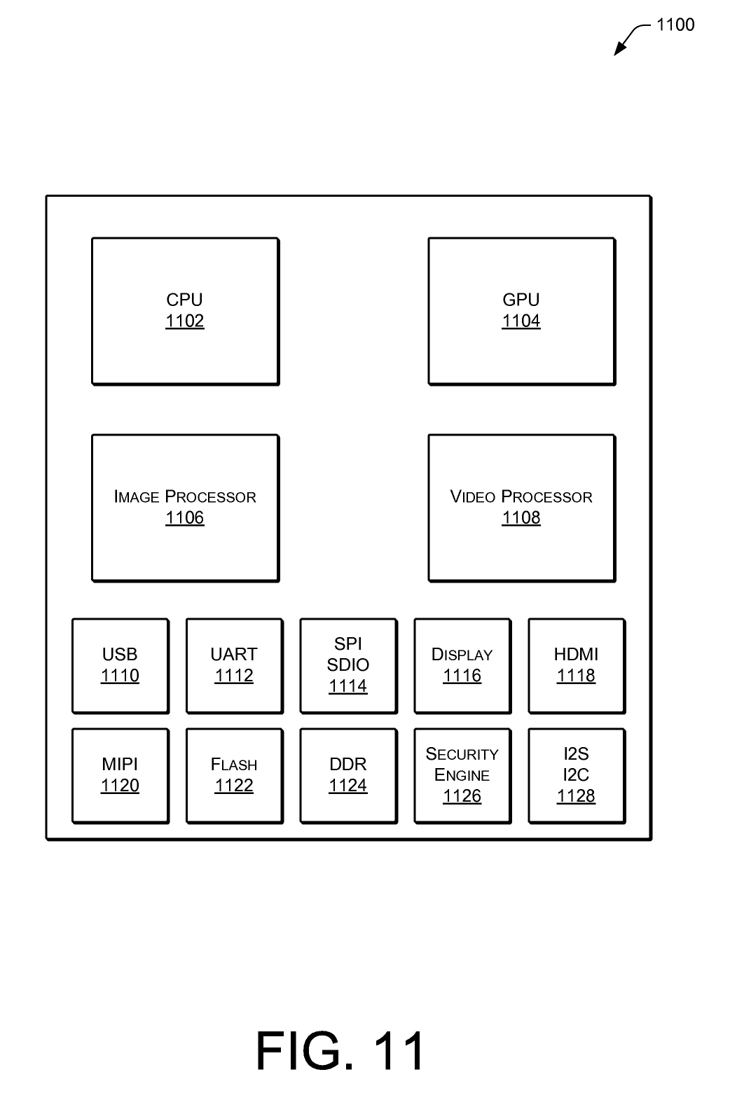

FIG. 11 illustrates a processor containing a central processing unit (CPU) and a graphics processing unit (GPU), which may perform instructions for handling core switching as described herein. In one embodiment, an instruction to perform operations according to at least one embodiment could be performed by the CPU. In another embodiment, the instruction could be performed by the GPU. In still another embodiment, the instruction may be performed through a combination of operations performed by the GPU and the CPU. For example, in one embodiment, an instruction in accordance with one embodiment may be received and decoded for execution on the GPU. However, one or more operations within the decoded instruction may be performed by a CPU and the result returned to the GPU for final retirement of the instruction. Conversely, in some embodiments, the CPU may act as the primary processor and the GPU as the co-processor.

In some embodiments, instructions that benefit from highly parallel, throughput processors may be performed by the GPU, while instructions that benefit from the performance of processors that benefit from deeply pipelined architectures may be performed by the CPU. For example, graphics, scientific applications, financial applications and other parallel workloads may benefit from the performance of the GPU and be executed accordingly, whereas more sequential applications, such as operating system kernel or application code may be better suited for the CPU.

FIG. 11 depicts processor 1100 which comprises a CPU 1102, GPU 1104, image processor 1106, video processor 1108, USB controller 1110, UART controller 1112, SPI/SDIO controller 1114, display device 1116, memory interface controller 1118, MIPI controller 1120, flash memory controller 1122, dual data rate (DDR) controller 1124, security engine 1126, and 12S/12C controller 1128. Other logic and circuits may be included in the processor of FIG. 11, including more CPUs or GPUs and other peripheral interface controllers.

The processor 1100 may comprise one or more cores which are similar or distinct cores. For example, the processor 1100 may include one or more first cores 120(1)-120(C), second cores 128(1)-128(S), and so forth. In some implementations, the processor 1100 may comprise a single type of core such as the first core 120, while in other implementations, the processors may comprise two or more distinct types of cores, such as the first cores 120, the second cores 128, and so forth.

One or more aspects of at least one embodiment may be implemented by representative data stored on a machine-readable medium which represents various logic within the processor, which when read by a machine causes the machine to fabricate logic to perform the techniques described herein. Such representations, known as “IP cores” may be stored on a tangible, machine readable medium (“tape”) and supplied to various customers or manufacturing facilities to load into the fabrication machines that actually make the logic or processor. For example, IP cores, such as the Cortex™ family of processors developed by ARM Holdings, Ltd. and Loongson IP cores developed the Institute of Computing Technology (ICT) of the Chinese Academy of Sciences may be licensed or sold to various customers or licensees, such as Texas Instruments, Qualcomm, Apple, or Samsung and implemented in processors produced by these customers or licensees.

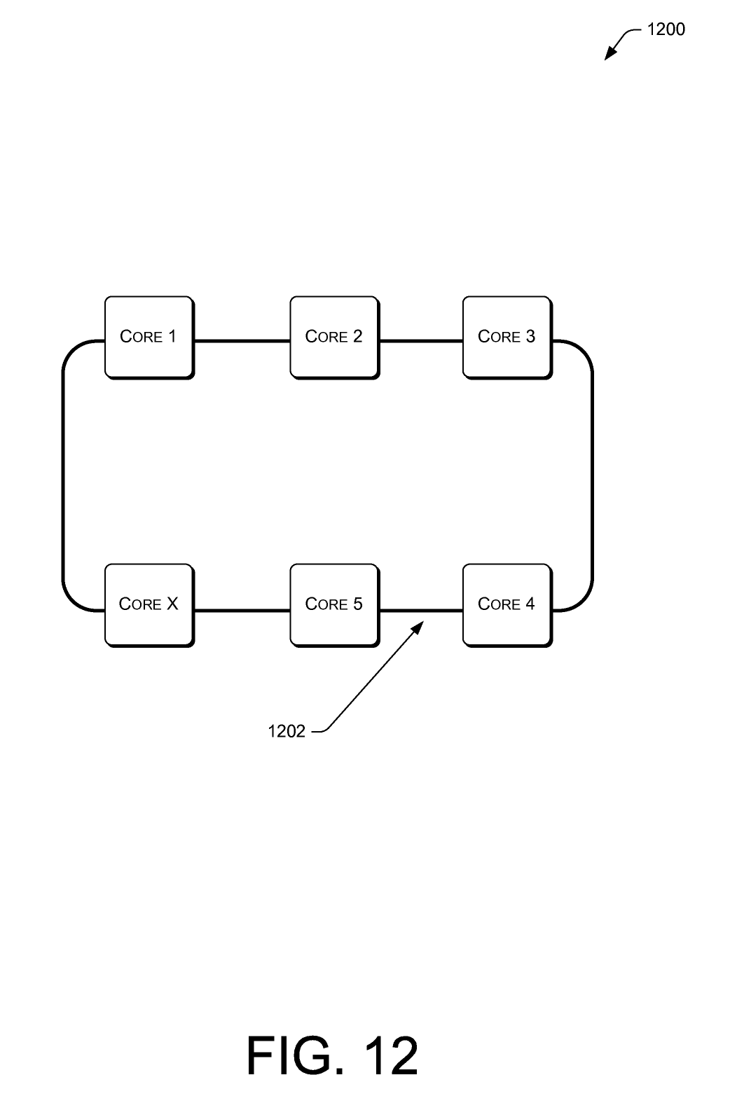

FIG. 12 is a schematic diagram of an illustrative asymmetric multi-core processing unit 1200 that uses an interconnect arranged as a ring structure 1202. The ring structure 1202 may accommodate an exchange of data between the cores 1, 2, 3, 4, 5, . . . , X. As described above, the cores may include one or more of the first cores 120 and one or more of the second cores 128.

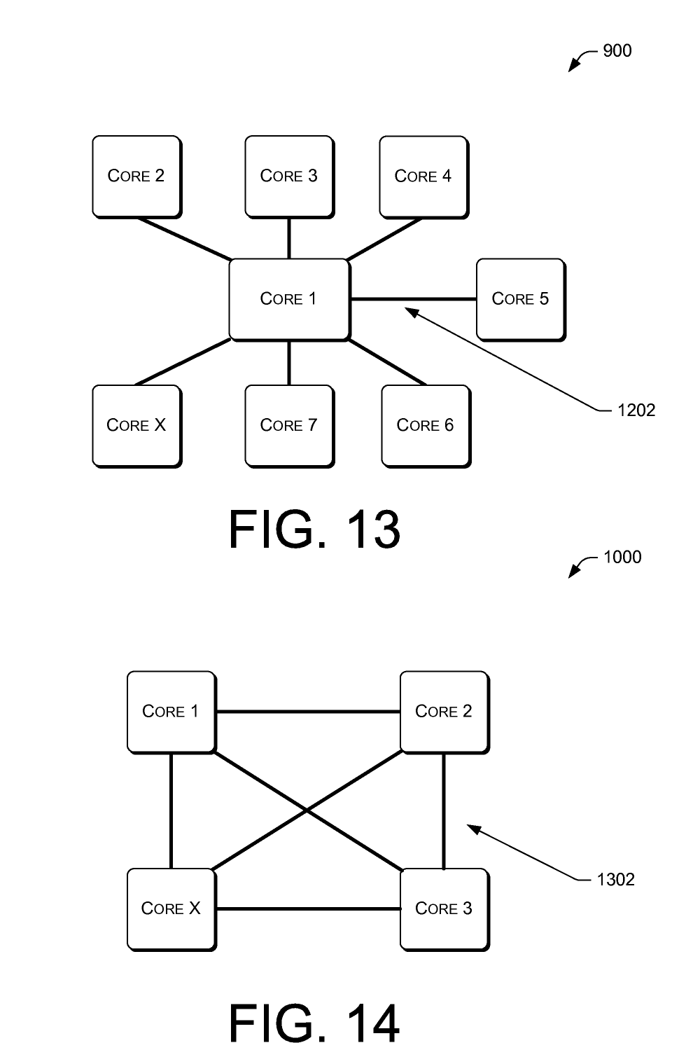

FIG. 13 is a schematic diagram of an illustrative asymmetric multi-core processing unit 1300 that uses an interconnect arranged as a mesh 1302. The mesh 1302 may accommodate an exchange of data between a core 1 and other cores 2, 3, 4, 5, 6, 7, . . . , X which are coupled thereto or between any combinations of the cores.

FIG. 14 is a schematic diagram of an illustrative asymmetric multi-core processing unit 1400 that uses an interconnect arranged in a peer-to-peer configuration 1402. The peer-to-peer configuration 1402 may accommodate an exchange of data between any combinations of the cores.

### CONCLUSION

Although the subject matter has been described in language specific to structural features and/or methodological acts, it is to be understood that the subject matter defined in the appended claims is not necessarily limited to the specific features or acts described. Rather, the specific features and acts are disclosed as illustrative forms of implementing the claims. For example, the methodological acts need not be performed in the order or combinations described herein, and may be performed in any combination of one or more acts.

What is claimed is:

1. A device comprising:
a control unit to select whether to execute a code segment on a first core or translate the code segment for execution on a second core;
a migration unit to accept the selection to execute the code segment on the first core and migrate the code segment to the first core; and
a binary translator unit to accept the selection to translate the code segment and generate a binary translation of the code segment to execute on the second core;

2. The device of claim 1, the first core to execute instructions from a first instruction set architecture and the second core to execute instructions from a second instruction set architecture comprising a subset of the first instruction set architecture.

3. The device of claim 1, further comprising a translation blacklist unit to maintain a list of instructions to not perform binary translation on.

4. The device of claim 1, the selecting whether to execute or translate the code segment comprising determining a code segment length and translating when the code segment length is below a pre-determined length threshold.

5. A processor comprising:
a first core to operate at a first maximum power consumption rate;
a second core to operate at a second maximum power consumption rate which is less than the first maximum power consumption rate; and
remap and migrate logic to select:
when to execute program code on the first core without binary translation; and
when to apply binary translation to the program code to generate translated program code and execute the translated program code on the second core.

6. The processor of claim 5, the selection of the remap and migrate logic to reduce overall power consumption of the first and second core during execution of the program code as compared to when no selection takes place.

7. The processor of claim 5, the selection by the remap and migrate comprising:
determining a length of a code segment in the program code which calls one or more instructions associated with a first instruction set architecture implemented by the first core;
when the one or more instructions are not on a translation blacklist, determining a length of the code segment;
when the length of the code segment is less than a pre-determined threshold:
translating the code segment to execute on a second instruction set architecture implemented by the second core;
executing the translated code segment on the second core;
when the length of the code segment is not less than a pre-determined threshold:
migrating the code segment to the first core;
executing the code segment natively on the first core;
when the one or more instructions are on a translation blacklist:
migrating the code segment to the first core; and
executing the code segment natively on the first core.

8. The processor of claim 5, the selection by the remap and migrate comprising:
receiving from the second core a fault indicating a faulting instruction calling for a first instruction set architecture;
when an instruction fault counter is below a pre-determined threshold, resetting the instruction fault counter after a pre-determined interval;
when the faulting instruction is not on a translation blacklist:
translating a code segment of the program code which contains the faulting instruction to a second instruction set architecture;
instrumenting the translated code segment to increment the instruction fault counter when the faulting instruction is executed;
executing the instrumented translated code on the second core implementing the second instruction set architecture and incrementing the fault counter as faulting instructions are called;
when the faulting instruction is on a translation blacklist:
migrating the code segment containing the faulting instruction to the first core implementing the first instruction set architecture;
executing the code segment containing the faulting instruction on the first core; and
when the instruction fault counter is not below the pre-determined threshold, adding the faulting instruction to the translation blacklist.

9. The processor of claim 5, the selection comprising:
receiving from the second core a fault indicating a faulting instruction calling for a first instruction set architecture;
when the fault is not a first fault:
when an instruction fault counter is below a pre-determined threshold, resetting a fault counter after a pre-determined interval;
when the faulting instruction is not on a translation blacklist:
translating a code segment of the program code which contains the faulting instruction to a second instruction set architecture;
instrumenting the translated code segment to increment the instruction fault counter when the faulting instruction is executed;
executing the instrumented translated code on the second core implementing the second instruction set architecture and incrementing the fault counter as faulting instructions are called;
when the instruction fault counter is not below the pre-determined threshold, adding the faulting instruction to the translation blacklist;
when the faulting instruction is on a translation blacklist:
migrating the code segment containing the faulting instruction to the first core implementing the first instruction set architecture;
executing the code segment containing the faulting instruction on the first core; and
when the fault is a first fault, proceeding to the translation and migrating concurrently.

10. The processor of claim 5, further comprising binary analysis logic to:
determine when one or more instructions in the program code will generate a fault when executed on the second core and not generate a fault when executed on the first core;
add the one or more faulting instructions to a translation blacklist;
migrate the program code containing the faulting instruction to the first core implementing the first instruction set architecture; and
execute the program code containing the faulting instruction on the first core.

11. The processor of claim 5, the remap and migrate logic further to:
migrate the program code from the second core to the first core;
execute an increment of a cycle execution counter on the first core; and
prevent migration from the first core to the second core until the cycle execution counter reaches a pre-determined cycle execution counter threshold.

12. The processor of claim 5, the remap and migrate logic further to:
migrate the program code from the second core to the first core;
execute an increment of a cycle execution counter on the first core;
reset the cycle execution counter upon encountering an instruction which would have faulted during execution on the second core;
prevent migration to the second core until the cycle execution counter reaches a pre-determined cycle execution counter threshold.

13. The processor of claim 5, binary analysis logic further to:
determine code segments of a pre-determined length in the program code will execute without fault on the second core; and
migrate the code segments from the first core to the second core.

14. A method comprising:
receiving, into a memory, program code for execution on a first processor or a second processor, wherein the first processor and the second processor utilize different instruction set architectures;
determining when to execute the program code on the first processor; and
determining when to apply binary translation to the program code to generate translated program code and execute the translated program code on the second processor.

15. The method of claim 14, the determining when to apply the binary translation to the program code comprising comparing a length of a code segment calling one or more instructions associated with one of the instruction set architectures to a pre-determined threshold length.

16. The method of claim 14, the determining when to execute the program code on the first processor comprising comparing instructions in the program code to a translation blacklist.

17. The method of claim 14, the determining when to execute the program code on the first processor without binary translation comprising comparing instructions in the program code to a translation blacklist.

18. The method of claim 14, further comprising:
executing the program code on the first processor while concurrently generating the translated program code; and
when the translated program code is generated, migrating the program code from the first processor to the second processor, using the translated program code.

19. The method of claim 14, the determining when to apply the binary translation comprising determining power consumption of the program code as executed on the first processor and on the second processor.

20. The method of claim 14, further comprising performing binary analysis on the program code to determine when an instruction in the program code will generate a fault when executed on the second processor and not the first processor, and the determining when to apply binary translation to the program code being based upon the binary analysis.
